(19) United States
(12) Patent Application Publication
(10) Pub. No.: US 2014/0110039 A1
(43) Pub. Date: Apr. 24, 2014

(54) PVB FILM WITH HIGH UV PROTECTION AND LOW YELLOWNESS INDEX FOR LAMINATED SAFETY GLAZINGS

(71) Applicant: KURARAY EUROPE GMBH, HATTERSHEIM (DE)

(72) Inventors: Phillipp Lellig, Cologne (DE); Uwe Keller, Bonn (DE)

(73) Assignee: KURARAY EUROPE GMBH, HATTERSHEIM (DE)

(21) Appl. No.: 14/054,925

(22) Filed: Oct. 16, 2013

(30) Foreign Application Priority Data
Oct. 18, 2012 (EP) 12189149.3
Dec. 27, 2012 (EP) 12199448.7
Jan. 16, 2013 (EP) 13151519.9

(51) Int. Cl. C08K 13/02; B29C 65/48

(52) U.S. Cl. CPC C08K 13/02; B29C 65/48
USPC 156/109; 524/91

(57) ABSTRACT

The invention relates to a plasticizer-containing polyvinyl acetal film which has a transmission of less than 20% and a yellowness index db of less than 3 at 400 nm, containing at least one UV absorber of formula

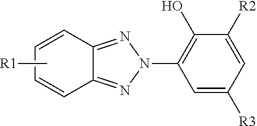

where R1 is H or halogen and R2 and R3 are C₁₋₂₀ alkyl-, hydroxyalkyl-, alkoxyalkyl-, acyloxyalkyl groups, optionally substituted by aldehyde, keto or epoxide groups,
and an antioxidant of formula

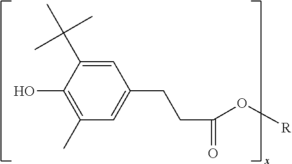

where R is hydrocarbon residue of a polyfunctional alcohol, an oligoglycol with 1 to 10 glycol units, or a hydrocarbon group with 1 to 20 carbon atoms, and s=1, 2, 3 or 4.

### CROSS-REFERENCE TO RELATED APPLICATIONS

This application claims priority to European Patent Application Nos. 13151519.9 filed Jan. 16, 2013, European Patent Application No. 12199448.7 filed Dec. 27, 2012 and European Patent Application No. 12189149.3 filed Oct. 18, 2012, the disclosures of which are incorporated in their entirety by reference herein.

### BACKGROUND OF THE INVENTION

1. Field of the Invention

The invention relates to plasticizer-containing, polyvinyl acetal-based films with high UV protection, as well as to glass laminates manufactured with them.

2. Background Art

Commercially available plasticizer-containing polyvinyl butyral film (PVB film) for laminated glasses has been formulated for many decades with UV absorbers so that UV radiation, unlike visible light, is not able to fully penetrate the laminated glass. In this way, protection from harmful UV radiation can be ensured in a simple manner for people or objects behind the laminated glass. Besides protecting from cuts due to glass breakage, this characteristic constitutes a substantial advantage over monolithic glass, since the latter is transparent to UV radiation for the most part.

Derivatives of 2-hydroxyphenylbenzotriazole in particular have been widely used with success and are available with different substitution patterns, for example under the trade names Tinuvin P, Tinuvin 328, Tinuvin 327, and Tinuvin. UV absorbers of the benzotriazole type are known in PVB film for their outstanding long-term stability, good solubility and high absorption performance over the entire UV range. Depending on the substitution pattern, absorption of greater or lesser intensity occurs even in the visible range of the spectrum, with the consequence that these UV absorbers can cause a certain yellow discoloration of the PVB film depending on the quantity used and on the distribution of substituents. For this reason, PVB films with a proportion of UV absorbers that is slightly higher than the standard quantities used already exhibit a measurably elevated yellowness index. Consequently, only certain types and quantities of UV absorbers are used such that complete absorption of the radiation (radiation transmission less than 1%) in the UVA range is only achieved up to a wavelength of approximately 370 nm. In the range from 370-400 nm, the radiation transmission is only reduced and the laminated glass remains partially transparent in this range.

In addition to UV absorbers, polyvinyl butyral is often furnished with phenolic antioxidants whose task it is, for example, to suppress radical cleavage reactions triggered during film extrusion as a result of high processing temperatures. In this way, the length of the polymer chains is maintained substantially constant so that the mechanical properties of the extruded material are not diminished as a consequence of the extrusion process.

However, many phenolic antioxidants are associated with the drawback that they cause yellow discoloration, depending on the extrusion conditions, that can be attributed to reaction products of the antioxidants. Even in a finished PVB film that is already adhered between two glass pane, phenolic antioxidants can subsequently cause yellowing under UV radiation—particularly at high temperatures—which is not only disadvantageous for aesthetic reasons but also reduces the light transmission of the glass laminate.

Especially the commercially most important group of phenolic antioxidants with the substructure (2,5-di-tert-butyl-4-hydroxyphenyl)propionate, which includes, among others, products such as Irganox 1010, Irganox 1076 and Irganox 1035, as well as those such as Hostanox 03, lead to yellowing in the glass laminate when used in PVB film under the action of UV radiation and/or temperature.

While protection from UV radiation up to a wavelength of 370-380 nm is sufficient for the majority of applications in laminated safety glass, there are special applications in which the complete absorption of the radiation up to a wavelength of 400 nm is desirable. For instance, to protect paintings in museums, to protect textiles in display windows or in motor vehicles, complete absorption of the UV radiation is necessary in order to prevent photochemically initiated decomposition and ageing processes of especially light-sensitive materials. Such protection from UV radiation can also be desirable in photovoltaic modules or in display applications.

For protection from UV radiation, US2009/0035583 A1 and U.S. Pat. No. 5,618,863 disclose the use of benzotriazoles as a UV stabilizer in films for laminated safety glass. These publications do not give any indication of the yellowing of the film under sunlight or their yellowness index.

### SUMMARY OF THE INVENTION

It is the object of the present invention to provide an adhesive film, for example for laminated glass, which, at a wavelength of 400 nm, has low transmission, a low yellowness index and sufficient light transmission in the visible range. Surprisingly, it was found that despite the use of increased quantities of UV absorber of the benzotriazole type according to formula (1), a plasticizer-containing polyvinyl film can be manufactured which, with a radiation transmission of under 20% up to a wavelength of 400 nm, offers substantially improved UV protection while at the same time exhibiting an only slightly increased yellowness index. This is achieved through the inventive selection of UV stabilizers and antioxidants.

### BRIEF DESCRIPTION OF THE DRAWINGS

FIG. 1 compares the transmission of an inventive and a non-inventive laminate.

FIG. 2 illustrates the correlation between UV stabilizer concentration with transmission and yellowness index.

### DETAILED DESCRIPTION OF THE PREFERRED EMBODIMENT(S)

Constituting the object of the present invention are therefore plasticizer-containing films which, in a thickness of 0.76 mm measured according to EN 410 between 2×2 mm float gas, has at 400 nm a transmission of less than 20% and a yellowness index db of less than 3, containing at least one polyvinyl acetal, at least one plasticizer and at least one UV absorber, the film containing:

as a UV absorber 0.5 to 5 wt. % of one or more compounds of the formula (1)

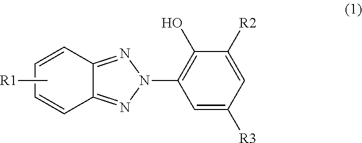

where R1 is H or a halogen atom and R2 and R3 are alkyl-, hydroxyalkyl-, alkoxyalkyl-, or acyloxyalkyl groups with 1 to 20 carbon atoms, each unsubstituted or substituted by aldehyde, keto or epoxide groups

and as antioxidants, 0.005-0.5 wt. % at least one compound of the formula (3)

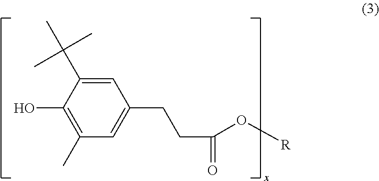

where R is a hydrocarbon radical of a polyfunctional alcohol, oligoglycols with 1 to 10 glycol units, or hydrocarbon groups with 1 to 20 carbon atoms and x=1, 2, 3 or 4.

As antioxidants according to formula 3, particularly binuclear phenolic antioxidants of the type of Lowinox 44B25 or Irganox 129, mononuclear antioxidants of the type of Songsorb 2908 (CAS: 67845-93-6), BHT (CAS: 128-37-0), p-octylphenol or polynuclear compounds such as, for example, Topanol CA (CAS: 1843-03-4) or Wingstay L (31851-03-3) can be used.

Preferably, such UV absorbers according to formula 1 are used in which the group R1 is a chlorine atom.

Most preferably, films according to the invention contain, as UV absorbers according to formula 1, 2-(3-tert-butyl-2-hydroxy-5-methylphenyl)-5-chloro-2H-benzotriazole, CAS no. 3896-11-5 as UV absorbers. This is commercially available, for example, from CIBA as “Tinuvin 326,” from BASF as “Uvinul 3026” or from Everlight Chemical as “Eversorb 73.”

In a first variant of the invention, films according to the invention contain UV absorbers according to formula (1) in a quantity of 0.5 to 5 wt. %, preferably 0.7 to 3 wt. % and most preferably 0.8 to 1.5 wt. %.

In a second variant of the invention, films according to the invention contain UV absorbers according to formula (1) in a quantity of 5 to 2.5 wt. %, preferably 4.0 to 2.5 wt. %.

In addition to the compounds according to formula (3), films according to the invention can contain other antioxidants. Since when the UV absorbers of the 2-hydroxyphenylbenzotriazole type are used in the quantity according to the invention the substantially reduced proportion of UVA radiation can result in yellow-colored decomposition products arising from certain antioxidants no longer being able to be whitened by radiation, it is preferred that such antioxidants are used that do not contain a (2,5-di-tert-butyl-4-hydroxyphenyl)propionate substructure or a Hostanox 03 type structure, i.e. similar to bis[3,3-bis-(4′-hydroxy-3′-tert-butylphenyl)butanoic acid]-glycol ester (CAS 32509-66-3), herein referred to as “bis(hydroxyl, alkyl)-phenyl alkanoic acid glycol esters,” since these tend to already exhibit yellow coloration during extrusion.

In a third variant of the invention, it is therefore preferred that the film according to the invention contain less than 1500 ppm of antioxidants of the formula (2) with a (2,5-di-tert-butyl-4-hydroxyphenyl)propionate substructure or of the type of Hostanox 03,

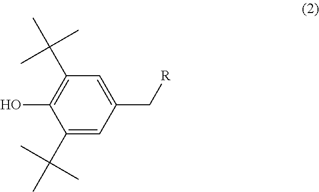

where R is a hydrocarbon radical of a polyfunctional alcohol, an oligoglycol with 1 to 10 glycol units, or a hydrocarbon group with 1 to 20 carbon atoms, N, P, or S-substituted hydrocarbon groups with 1 to 30 carbon atoms, or carboxylic acid ester groups with 1 to 30 carbon atoms in the alcohol residue of the ester.

Preferably, the film according to the invention does not contain such antioxidants at all or contains them only in a very small proportion, i.e., preferably no more than 1000 ppm, more preferably no more than 500 ppm, and with increasing preference, no more than 250 ppm, no more than 100 ppm, and no more than 50 ppm, and most preferably 0 ppm.

Examples of compounds of the formula (2) that are not used in the third variant or only in a small proportion are those with the following CAS numbers: 2082-79-3, 12643-61-0, 35074-77-2, 23128-74-7, 976-56-7, 65140-91-2, 1709-70-2, 34137-09-2, 27676-62-6, 6683-19-8, 41484-35-9, 991-84-4, 63843-89-0, 4221-80-1 and 67845-93-6.

Likewise, examples of compounds of the formula (2) that are not used in the third variant or only in small proportions are compounds according to the following structural formulas:

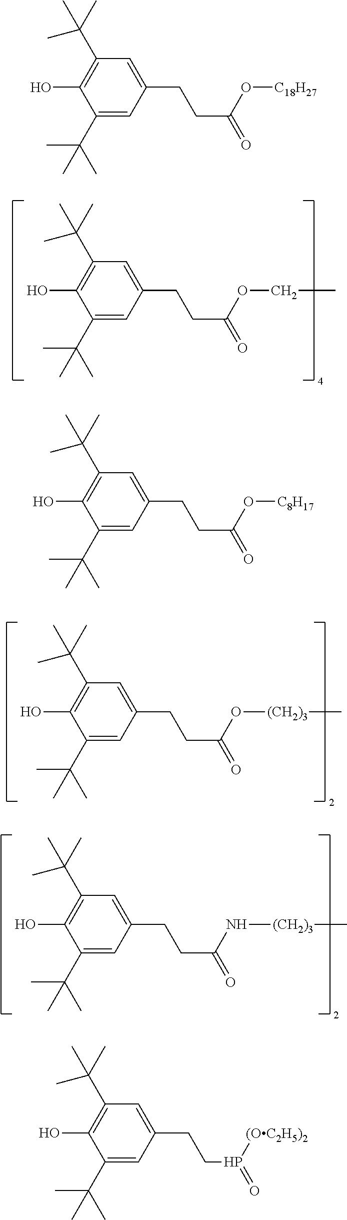

(selected compounds of the formula 2)

Compounds of this kind can be found, for example, in the “Plastics Additives Handbook,” 5th Edition, Hanser-Verlag in the chapter “Primary antioxidants.”

Antioxidants used according to the invention which do not contain the (2,5-di-tert-butyl-4-hydroxyphenyl)propionate substructure or a structure of the Hostanox 03 type can be contained in the film in a quantity of 0.005 to 0.5 wt. %, preferably 0.02 to 0.15 wt. % and most preferably 0.03 to 0.1 wt. %. Such suitable antioxidants are, for example, compounds of the formula (3) or binuclear phenolic antioxidants of the Lowinox 44B25 or Irganox 129 types, mononuclear antioxidants such as Songsorb 2908 (CAS: 67845-93-6), BHT (CAS: 128-37-0), p-octylphenol, and polynuclear antioxidants such as, for example, Topanol CA (CAS: 1843-03-4) or Wingstay L (31851-03-3),

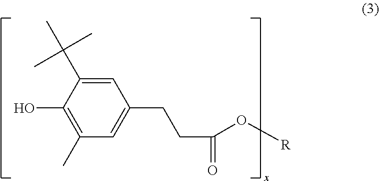

where R is a hydrocarbon radical of a polyfunctional alcohol, an oligoglycol with 1 to 10 glycol units, or a hydrocarbon group with 1 to 20 carbon atoms and x=1, 2, 3 or 4.

Also worthy of consideration are phenolic antioxidants containing one or more sulfur atoms but which do not contain the (2,5-di-tert-butyl-4-hydroxyphenyl)propionate substructure or that of the type of Hostanox 03. Particularly, antioxidants according to formula (3) can be triethyleneglycol-bis-3-(3-tert-butyl-4-hydroxy-5-methylphenyl)propionate, CAS no. 36443-68-2. This is commercially available, for example from Songwon as “Songnox 2450” or from CIBA as “Irganox 245.”

As will readily be understood, additional analogous structures can easily be generated by varying the substituents that can be used accordingly in the framework of the invention.

Films according to the invention, in a thickness of 0.76 mm measured according to EN 410 between 2×2 mm float glass have a transmission at 400 nm of less than 20%, more preferably less than 10%, yet more preferably less than 5%, still more preferably less than 3% and especially less than 1%.

Moreover, films according to the invention have a UV transmission according to ISO 13837 Conv. A (300-400 nm) of less than 1%, preferably less than 0.5%, and especially less than 0.05%.

At the same time, the yellowness index (db) of films according to the invention is less than 3, preferably less than 2.5, more preferably less than 2 and especially less than 1.8. The measurement of the yellowness index (db) is described in the examples. The yellowness can also be determined by the transmission of the film at 430 nm according to EN 410. Particularly, at a thickness of 0.76 mm in a laminate between two panes of clear glass (z Planilux) each with a thickness of 2 mm, films according to the invention have a light transmission at 430 nm according to EN 410 of greater than 75%, and in increasing order of preference, greater than 80%, 85%, 86%, 87% or 88%.

As will readily be understood, the values for the transmission at 400 nm and for the yellowness index change accordingly when the film thickness is varied.

In addition to the use of suitable UV absorbers and antioxidants, the setting of a low alkali titer of the mixture according to the invention, for example in the neutralization of the polyvinyl acetal, can bring about improved inherent color and photothermal stability of the film according to the invention. As indicated in the examples, the alkali titer is determined through neutralization of the mixture or film according to the invention with hydrochloric acid and preferably lies between 2 and 70, particularly between 3 and 50 and most preferably between 5 and 30.

The setting of the alkali titer can be done through commensurate neutralization of the polyvinyl acetal during or after preparation thereof through acetalization of polyinyl alcohol or through the addition of metal salts to the mixture according to the invention. When the films according to the invention are used for glass laminates, the metal salts generally also act as anti-adhesive agents.

Films according to the invention can contain alkaline earth metal, zinc, aluminum or alkali metal ions as anti-adhesive agents. These are present in the mixture/film in the form of the salts of mono- or polynuclear inorganic or mono- or polynuclear organic acids. Examples of counterions are, for example, salts of organic carboxylic acids such as formates, acetates, trifluoroacetates, propionates, butyrates, benzoates, 2-ethylhexanoates, etc., with carboxylic acids with fewer than 10 C-atoms, preferably fewer than 8, more preferably fewer than 6, yet more preferably fewer than 4 and especially fewer than 3 C-atoms preferably being used. Examples of inorganic counterions are chlorides, nitrates, sulfates and phosphates. Additional counterions can be anions associated with the surfactants, such as sulfonate or phosphate surfactants.

Preferably, the film according to the invention contains more than 5 ppm, preferably more than 10 ppm, yet more preferably more than 15 ppm, still more preferably more than 20 ppm, and especially more than 25 ppm of ions selected from the group of the alkaline earth metals (Be, Mg, Ca, Sr, Ba, Ra), zinc and aluminum. However, in order to prevent undesired clouding, no more than 250 ppm of the cited polyvalent metals should be present.

At the same time, the alkali metal ion content (Li, Na, K, Rb, Cs, Fr) in the plasticizer-containing, polyvinyl acetal-based film should be set as low as possible. Preferably, the film contains less than 150 ppm, more preferably less than 100 ppm, yet more preferably less than 75 ppm, still more preferably less than 50 ppm, yet still more preferably less than 25 ppm, even more preferably less than 10 ppm, and especially less than 5 ppm alkali metal ions.

Surprisingly, it was found that increased quantities of the benzotriazole UV absorbers used according to the invention do not have a negative impact on adhesion despite the ability to complex bivalent metal ions. Particularly, it is possible to set reduced adhesion levels such as those required when using PVB/glass laminates in the automobile sector in order to achieve sufficient penetration resistance. Films according to the invention in the laminate between two panes of clear glass (2 mm Planilux®) have shear strengths of 6-30 N/mm², especially of 8-20 N/mm² and particularly of 9-16 N/mm².

The polyvinyl acetals used according to the invention are available as acetalization products of polyvinyl alcohol (PVA) with aldehydes such as butyraldehyde. Films according to the invention can contain one or more polyvinyl acetals that can differ in terms of molecular weight, degree of acetyalization, residual alcohol content or number of carbon atoms in the acetal group.

Moreover, the abovementioned favorable optical characteristics of the film according to the invention can be improved through selection of the polyvinyl alcohol (PVA) used to manufacture the polyvinyl acetal. If unsaturated units are present in the PVA in the polymer chain as defects, they are inevitably also found in the polyvinyl acetal produced from it, resulting in its increased absorption of UV radiation and reduced light stability. The unsaturated units can be present in the form of isolated double bonds or double bonds in conjugation with carbonyl bonds. These unsaturated units can be detected in the PVA using UV spectroscopy.

In measurements of the PVA in 4 wt. % solution in H₂O, very high proportions of defects lead to extinctions at 280 nm of near 1. For this reason, to manufacture the polyvinyl acetal used according to the invention, polyvinyl alcohols are preferably used that have extinction values of less than 0.5, preferably less than 0.3, particularly 0.2 or less and preferably 0.1 or less in a 4 wt. % solution at 280 nm.

In addition to the use of a UV absorber in increased quantity and the use of phenolic antioxidants that do not tend to yellow and/or the use of especially defect-free polyvinyl acetals and/or the setting of the alkali titer, the films according to the invention can be provided with one or more non-aromatic light stabilizers, particularly with sterically hindered amines of the HALS type and/or sterically hindered amino ethers (NOR-HALS).

Films according to the invention preferably contain 0.005-1 wt. %, more preferably 0.01-0.5 wt. %, yet more preferably 0.03-0.3 wt. % and most preferably 0.05-0.25 wt. % sterically hindered amines of the HALS or NOR-HALS type as light stabilizers.

Especially suitable sterically hindered amines are those of the general formulas (5), (6) and/or (7).

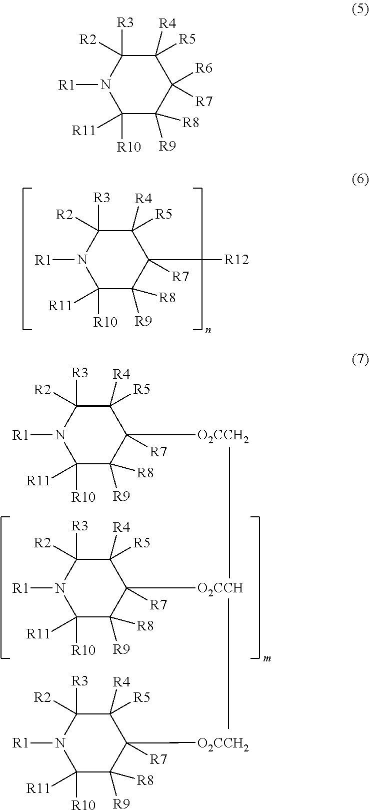

where R1, R2, R3, R4, R5, R6, R7, R8, R9, R10, R11 are H, C1-C20 alkyl, hydroxyalkyl, alkoxyalkyl, or acyloxyalkyl, each unsubstituted or substituted by aldehyde, keto or epoxide groups
R12 is a covalent bond or a C1-C₂₀ alkyl, hydroxyalkyl, alkoxyalkyl, or acyloxyalkyl group, each unsubstituted or substituted by aldehyde, keto or epoxide groups
n is 2-4, and
m is 1-10.

Compounds of this type are commercially available, for example in the products Tinuvin 123 (NOR-HALS), Tinuvin 144, Tinuvin 622, Tinuvin 770 and its di-N-methylated derivative from BASF (Ciba Specialities). For example, Songlight 2920 from the company Songwon International, ADK Stab LA-57, LA-52 or LA-62 from the company Asahi Denim Co. or UVINUL 4050 H from BASF SE are especially well suited.

To prepare polyvinyl acetals, polyvinyl alcohol is dissolved in water and acetalated with an aldehyde such as, for example, butyraldehyde, formaldehyde or propionaldehyde under the action of an acid catalyst. The precipitated polyvinyl acetal is separated, washed until neutral, optionally suspended in an alkalized aqueous medium, then washed again to neutral and dried.

The acid used for acetalization must be neutralized after the reaction. A small alkali metal ion content can be obtained, among other ways, during the synthesis of the polyvinyl acetal by doing without the sodium or potassium hydroxides or carbonates usually used to neutralize the catalyst or through thorough washing of the polyvinyl acetal obtained during acetalization. Alternatively to the bases NaOH or KOH, the catalyst acid from the acetalization step can be neutralized, for example, by injecting carbon dioxide or ethylene oxide.

The polyvinyl alcohol content of the polyvinyl acetal can be adjusted through the amount of the aldehyde used during acetalization.

It is also possible to perform the acetalization with other or several aldehydes with 2-10 carbon atoms (valeraldehyde, for example).

The films based on plasticizer-containing polyvinyl acetal preferably contain uncrosslinked polyvinyl butyral (PVB), which is obtained through acetalization of polyvinyl alcohol with butyraldehyde.

The use of cross-linked polyvinyl acetals, particularly cross-linked polyvinyl butyral (PVB), is also possible. Suitable cross-linked polyvinyl acetals are described, for example, in EP 1527107 B1 and WO 2004/063231 A1 (thermal self-cross-linking of carboxyl group-containing polyvinyl acetals), EP 1606325 A1 (polyvinyl acetals cross-linked with polyaldehydes) and WO 03/020776 A1 (polyvinyl acetals cross-linked with glyoxylic acid). The disclosure of these patent applications is fully incorporated herein by reference.

In the framework of the present invention, terpolymers from hydrolyzed vinyl acetate/ethylene copolymers can also be used as the polyvinyl alcohol. These compounds are generally hydrolyzed to more than 98 mol % and contain 1 to 10 by weight of ethylene-based units (for example, the “Exceval” type from Kuraray Europe GmbH).

Moreover, in the framework of the present invention, hydrolyzed copolymers of vinyl acetate and at least one other ethylenically unsaturated monomer can also be used as a polyvinyl alcohol.

In the framework of the present invention, the polyvinyl alcohols can be used in pure form or as a mixture of polyvinyl alcohols with different degrees of polymerization and/or degrees of hydrolysis.

In addition to the acetal units, polyvinyl acetals also contain units resulting from vinyl acetate and vinyl alcohol. The polyvinyl acetals used according to the invention have a proportion of polyvinyl alcohol of 12-24 wt. %, preferably 14-23 wt. %, more preferably 16-22 wt. %, yet more preferably 17-21 wt. % and in particular 18-20 wt. %.

The polyvinyl acetate content of the polyvinyl acetal used according to the invention is, with increasing preference, under 5 wt. %, under 3 wt. % or under 1 wt. %, especially under 0.75 wt. %, more especially under 0.5 wt. % and in particular under 0.25 wt. %.

The degree of acetalization can be determined by calculation from the polyvinyl alcohol portion and the residual acetate content.

Preferably, the films have a total plasticizer content, which is to say the proportion of all plasticizers in the film, in the ranges, in order of increasing preference, off from 5-45 wt. %, 12-36 wt. %, 14-32 wt. %, 16-30 wt. %, and particularly 20-28 wt. %. Films according to the invention and laminates adhered thereto can contain one or more plasticizers.

One or more of the compounds selected from the following group are well suited as plasticizers for the films according to the invention: di-2-ethylhexylsebacate (DOS), di-2-ethylhexyladipate (DOA), dihexyladipate (DHA), dibutylsebacate (DBS), triethylene glycol-bis-n-heptanoate (3G7), tetraethylene glycol-bis-n-heptanoate (4G7), triethylene glycol-bis-2-ethyl hexanoate (3GO or 3G8), tetraethylene glycol-bis-n-2-ethyl hexanoate (4GO or 4G8), di-2-butoxyethyl adipate (DBEA), di-2-butoxyethoxyethyl adipate (DBEEA), di-2-butoxyethyl sebacate (DBES), di-2-ethylhexyl phthalate (DOP), di-isononyl phthalate (DINP), triethylene glycol-bis-isononanoate, triethylene glycol-bis-2-propyl hexanoate, tris(2-ethylhexyl)phosphate (TOF), 1,2-cyclohexandicarboxylic acid diisononyl ester (DINCH), diisononyl adipate (DINA) and dipropylene glycol benzoate.

Especially suitable as plasticizers for the films according to the invention are plasticizers whose polarity, expressed by the formula 100×O/(C+H), is less than or equal to 9.4, with O, C and H standing for the number of oxygen, carbon and hydrogen atoms in the respective molecule. The following table shows plasticizers that can be used according to the invention and their polarity values according to the formula 100×O/(C+H).

| Name | Abbrev. | 100 × O/(C + H) |
|---|---|---|
| Di-2-ethylhexyl sebacate | (DOS) | 5.3 |
| Di-iso-nonyladipate | (DINA) | 5.3 |
| 1,2-cyclohexandicarboxylic acid | (DINCH) | 5.4 |
| diisononyl ester | | |
| Di-2-ethylhexyl adipate | (DOA) | 6.3 |
| Dihexyl adipate | (DHA) | 7.7 |
| Dibutyl sebacate | (DBS) | 7.7 |
| Triethylene glycol-bis-2-propyl | | 8.6 |
| hexanoate | | |
| Triethylene glycol-bis-i-nonanoate | | 8.6 |
| Di-2-butoxyethyl sebacate | (DBES) | 9.4 |
| Triethylene glycol-bis-2-ethyl | (3G8) | 9.4 |
| hexanoate | | |

Moreover, the mixtures or films according to the invention can additionally contain other additives such as, for example, antistatic agents, fillers, IR-absorbent nanoparticles or chromophores, dyes, surface-active substances, whiteners, stabilizers, acid/base buffers, chelating agents, compounds containing epoxy groups, pigments and adhesion regulators.

Films according to the invention can be used for the manufacture of laminated glass, which is to say for the adhesion of at least two glass panes or as a single glass pane layer to be joined with another transparent rigid or flexible layer. Such glasses can advantageously be used in cases where improved UV protection and simultaneously high transparency in the visible light range is important, such as in museums (so-called museum glass), display window glasses, motor vehicles (windshields, side windows, glass roofs and rear windows) or aircraft glasses. In particular, the films according to the invention can also be used in functional components such as photovoltaic modules (especially for those with organic solar cells), display applications (LED or OLED screens, televisions, computer screens, big screens), switchable glass elements (especially electrochromic, photochromic, photoelectrochromic elements, or of the “suspended particle device” or thermotropic type).

In the cited functional components, at least one layer of the film according to the invention protects an active layer arranged behind it from damage from sunlight or UV radiation. In the case of photochromic layers, their response characteristics, which are influenced more by visible light than by UV radiation, can additionally be modified by filtering out the UV component of the sunlight.

### Methods of Testing and Measurement:

The radiation-related properties (luminous transmittance TL, UV transmittance TUV, transmission at a given wavelength T400; each expressed in %) of the film with a thickness of 0.76 mm laminated between 2×2 mm Planilux® was determined according to DIN EN 410 on a Perkin-Elmer Lambda 950 UV/VIS spectrometer.

To determine the yellowness index db of the extruded film, a laminated glass with film with a thickness of 0.76 mm is measured with two panes of 2 mm Planilux® on the Color Quest XE with the setting Hunterlab 2°/C and the yellowness index of the laminate b(laminate) was determined in the CIELAB color space according to DIN EN ISO 11664-4. In this method, the yellowness index of the glass b(glass pair) is averaged out by calibration of the pair of panes of the identical glass lot as a zero sample, and the contribution of the intermediate later to the yellow coloration is determined numerically as yellowness index db=b(laminate)−b(glass pair).

To assess the adhesion of a PVB film, the compression shearing test was performed in accordance with DE 19756274 A1 on a glass/glass laminate. For this, 10 samples with dimensions of 25.4×25.4 mm at an angle of 45° with a feed rate of 1.5 mm/min were braced in a testing apparatus according to DE 19756274 A1 and measured. The maximum force that is required to shear off the film from the glass, with respect to the surface of the sample, was then averaged over the 10 samples.

### EXAMPLES

Films were manufactured with the mixtures having the compositions listed in the following tables and processed as a laminate between 2 Planilux®-type glass panes having a thickness of 2 mm and investigated.

Comparative Example 1 (C1) with an excessively low concentration of UV absorber of the benzotriazole type according to formula (1) exhibits a high transmission of radiation in the range from 380-400 nm.

Over the entire UVA range up to a wavelength of 400 nm, the laminate having a higher concentration of UV absorber according to inventive Example 1 possesses a transmission of less than 1%. At the same time, as a result of the use of a suitable antioxidant of the type of Songnox 2450, this film has a low yellowness index.

Inventive Example 2 shows that, even when 2000 ppm of the suitable antioxidant of the type of Songnox 2450, no significant increase in the yellowness index of the film occurs.

In contrast, if an antioxidant is used in the same concentration according to Example 2 that is unsuitable according to formula 2, then the film has a substantially elevated yellowness index, as shown by Comparative Example C2.

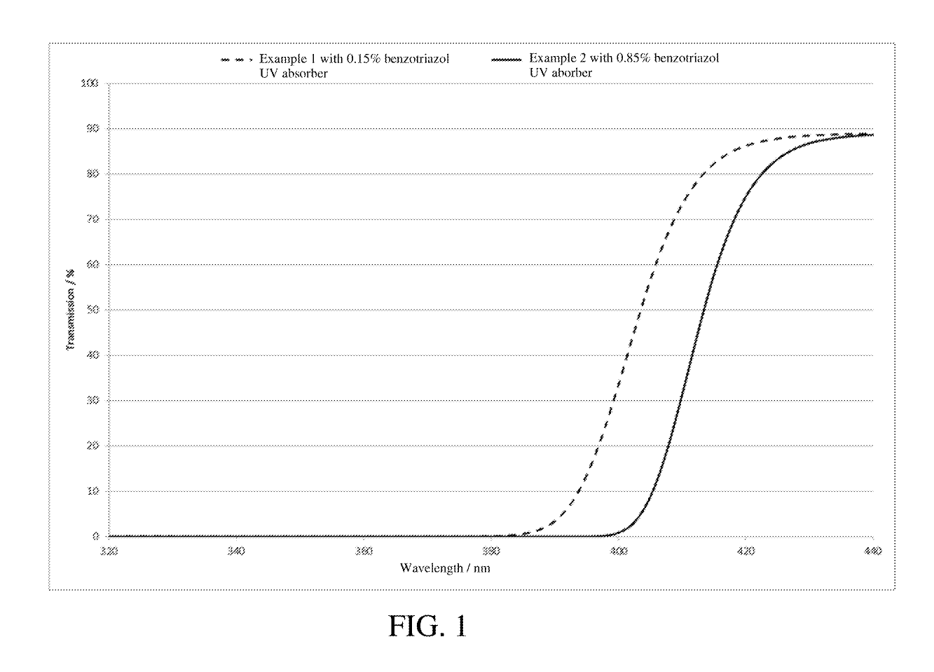

FIG. 1 shows the transmission of glass laminates according to Comparative Example 1 (C1) and inventive Example 1 in the range between 320 and 440 nm. By virtue of the inventive high concentration of the UV absorber, the absorption and transmission of the film is shifted to longer wavelengths. This results in protection from UV radiation practically up to the wavelengths of the visible range of light.

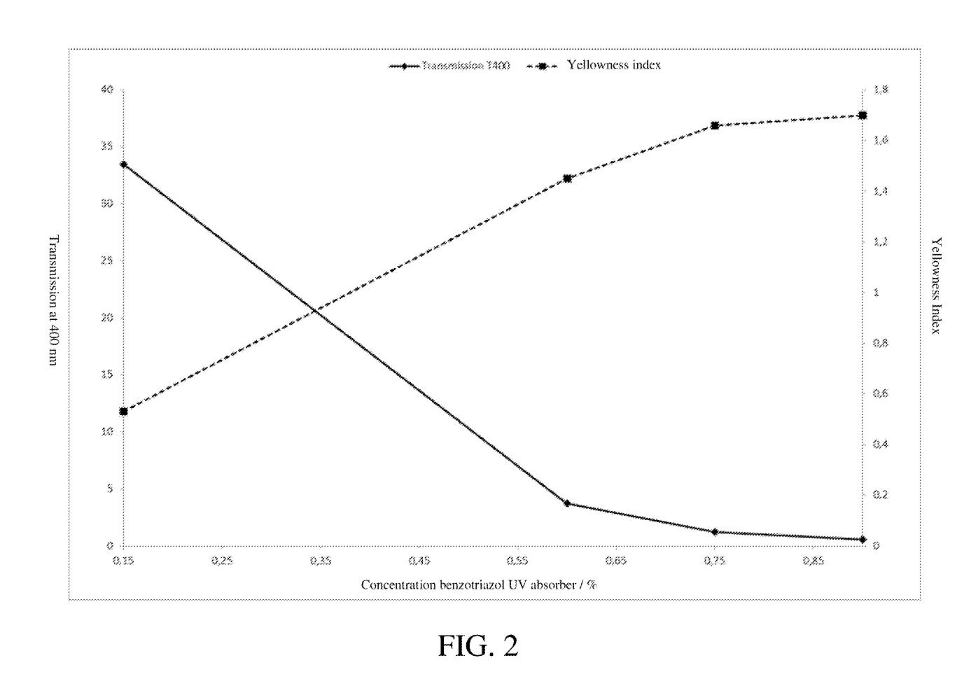

FIG. 2 shows the correlation between the concentration of UV stabilizer and the resulting UV transmission at 400 nm as well as the yellowness index. As can be seen, through the combination with a suitable antioxidant, an ever-lower UV transmission of the film at 400 nm can be achieved as the concentration of UV stabilizer increases, all without a pronounced increase in the yellowness index. This effect is achieved through the film composition according to the invention.

Consequently, films with a composition according to the invention are well suited to applications that require an especially high level of UV protection and simultaneously no restriction of the light transmission as a result of an initially excessively high yellowness index or subsequent yellowing on ageing.

TABLE 1

| Example/Comparative Example | C1 | 1 | 2 | C2 |
|---|---|---|---|---|
| Film thickness in mm | 0.76 | 0.76 | 0.76 | 0.76 |
| PVB^{(a)} | 72.5 | 72.5 | 72.5 | 72.5 |
| 3G8/DBEA 10:1^{(a)} | 27.5 | 27.5 | 27.5 | 27.5 |
| Tinuvin 326^{(a)} | 0.15 | 0.85 | 0.85 | 0.85 |
| MgAc₂•4 H₂O^{(a)} | 0.0375 | 0.0375 | 0.0375 | 0.0375 |
| Songnox 2450^{(a)} | 0.0365 | 0.0365 | 0.2 | 0 |
| Songnox 3114^{(a)} | 0 | 0 | 0 | 0.2 |
| TL % | 90.0 | 90.3 | 90.8 | 90.2 |
| TUV % | 3.4 | 0.03 | 0.04 | 0.03 |
| T400 % | 33.5 | 0.8 | 0.9 | 0.7 |
| db | 0.49 | 1.67 | 1.66 | 3.14 |
| Shear strength N/mm² | 14.9 | 10.1 | 12.7 | 13.1 |

Meanings of abbreviations:
PVB polyvinyl butyral
3G8 triethylene glycol-bis-2-ethylhexanoate
DBEA di-2-butoxyethyladipate (optionally in a weight-mixture ratio with 3G8)
Tinuvin 326 benzotriazole UV absorber of the type of Tinuvin 326
TL light transmission TL according to EN 410 (380-780 nm)
TUV UV transmission TUV according to ISO 13837 Conv. A (300-400 nm)
T400 transmission at 400 nm determined through light transmission measurement
db yellowness index db determined using Colorquest XE according to DIN EN ISO 11664-4
^{(a)}Data in wt. % with respect to the film

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A plasticizer-containing film comprising at least one polyvinyl acetal, at least one plasticizer, and further comprising:
as a UV absorber, 0.5 to 5 wt. % of one or more compounds of the formula (1) 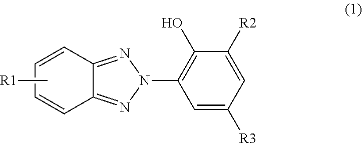
where R1 is H or a halogen and R2 and R3 are alkyl-, hydroxyalkyl-, alkoxyalkyl-, or acyloxyalkyl groups having 1 to 20 carbon atoms, each optionally substituted by aldehyde, keto or epoxide groups; and
as an antioxidant, 0.005-0.5 wt. % of at least one compound of the formula (3) 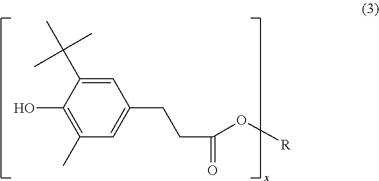
where R is a hydrocarbon residue of a polyfunctional alcohol, or an oligoglycol with 1 to 10 glycol units, or a hydrocarbon group with 1 to 20 carbon atoms and x is 1, 2, 3 or 4,
wherein the plasticizer-containing film, in a thickness of 0.76 mm measured between 2×2 mm float glass, has a transmission of less than 20% according to EN 410 and a yellowness index db of less than 3 at 400 nm,

2. The film of claim 1, wherein 2-(3-tert-butyl-2-hydroxy-5-methylphenyl)-5-chloro-2H-benzotriazol is used as a UV absorber of the formula (1).

3. The film of claim 1, wherein the film contains less than 1500 ppm of antioxidants of the formula (2) or a bis(hydroxyl, alkyl)-phenyl alkanoic acid glycol ester 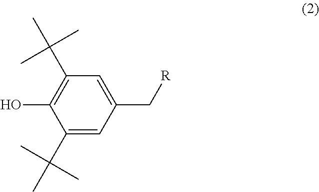
where R is a hydrocarbon residue of a polyfunctional alcohol, an oligoglycol with 1 to 10 glycol units, a hydrocarbon group with 1 to 20 carbon atoms, an N, P, S-substituted hydrocarbon group with 1 to 30 carbon atoms, or a carboxylic acid group with 1 to 30 carbon atoms in the alcohol group.

4. The film of claim 1, wherein the film has an alkali titer of 2-70.

5. The Film of claim 1, wherein the film contains 0.001 to 1 wt. % non-aromatic light stabilizers of the HALS and/or NOR-HALS type.

6. The film of claim 1, wherein the polyvinyl acetal is manufactured by acetalization of polyvinyl alcohol having an extinction at 280 nm of less than 0.5 in a 4 wt. % aqueous solution.

7. The film of claim 1, wherein the film has more than 5 ppm metal ions selected from the group of earth alkaline metals, zinc and aluminum, and has less than 150 ppm alkali metal ions.

8. The film of claim 1, wherein the film has a UV transmission according to ISO 13837 Conv. A (300-400 nm) of less than 1%.

9. The film of claim 1, wherein the film has a shear strength of 6-30 N/mm² in a laminate between two panes of clear glass.

10. The film of claim 1, wherein, in a thickness of 0.76 mm in a laminate between two panes of clear glass each with a thickness of 2 mm, the film has a light transmission at 430 nm according to EN 410 of greater than 75%.

11. In a process of preparing a laminate glazing selected from the group consisting of museum glasses, display window glasses, motor vehicle glasses, aircraft glasses, and photovoltaic modules, the improvement comprising laminating glass with a film of claim 1.
